(19) United States
(12) Patent Application Publication
(10) Pub. No.: US 2020/0353952 A1
(43) Pub. Date: Nov. 12, 2020

(54) INFORMATION PROCESSING APPARATUS, VEHICLE, MOBILE OBJECT, INFORMATION PROCESSING METHOD, AND PROGRAM

(71) Applicant: SONY CORPORATION, TOKYO (JP)

(72) Inventors: HIROTAKA SUZUKI, KANAGAWA (JP); TAKUYA NARIHIRA, TOKYO (JP); AKIRA NAKAMURA, KANAGAWA (JP)

(21) Appl. No.: 16/760,066

(22) PCT Filed: Oct. 30, 2018
(86) PCT No.: PCT/JP2018/040282

§ 371 Date: Apr. 29, 2020

(30) Foreign Application Priority Data
Nov. 8, 2017 (JP) 2017-215576

(51) Int. Cl. B60W 60/00; G06K 9/00; G08G 1/16; G01C 21/34

(52) U.S. Cl. CPC B60W 60/0025; G06K 9/00791; B60W 2556/45; G01C 21/3407; G06K 2209/23; G08G 1/16

(57) ABSTRACT

An information processing apparatus according to an embodiment of the present technology includes an acquisition unit and a first generation unit. The acquisition unit acquires movement information related to movement of another mobile object different from a target mobile object that is a control target. The first generation unit generates information related to a goal trajectory that is a goal for movement of the target mobile object on the basis of the acquired movement information of the other mobile object.

### TECHNICAL FIELD

The present technology relates to an information processing apparatus, a vehicle, a mobile object, an information processing method, and a program for controlling movement of the mobile object.

### BACKGROUND ART

Conventionally, technologies of automatically driving a mobile object such as a vehicle have been known. For example, Patent Literature 1 describes a vehicle control apparatus that achieves autonomous driving. A driving control unit of the vehicle control apparatus decides a driving route based on a driving lane, by using map information acquired from a map database on the basis of a destination input by a user and a current location detected by a GPS receiver. Acceleration, braking, steering, and the like are controlled on the basis of the driving route and information acquired by a sensor group installed in the vehicle. This makes it possible to achieve autonomous driving for driving a safe route (see paragraphs [0018], [0024], [0028] to [0030], FIG. 4, FIG. 5, and the like of Patent Literature 1).

### CITATION LIST

### Patent Literature

Patent Literature 1: WO 2016/194134

### DISCLOSURE OF INVENTION

### Technical Problem

In future, it is expected that technologies of automatically driving various mobile objects including the vehicle will be developed and the autonomous driving technologies will be widely used in actual movement environment such as a road. Technologies capable of flexibly controlling movement in conformity with such an actual movement environment have been desired.

In view of the circumstances as described above, a purpose of the present technology is to provide an information processing apparatus, a vehicle, a mobile object, an information processing method, and a program that are capable of flexibly controlling movement in conformity with an actual movement environment.

### Solution to Problem

In order to achieve the above-described purpose, an information processing apparatus according to an embodiment of the present technology includes an acquisition unit and a first generation unit.

The acquisition unit acquires movement information related to movement of another mobile object different from a target mobile object that is a control target.

The first generation unit generates information related to a goal trajectory that is a goal for movement of the target mobile object on the basis of the acquired movement information of the other mobile object.

The information processing apparatus acquires movement information related to movement of the other mobile object. Information related to a goal trajectory is generated on the basis of the acquired movement information. The goal trajectory is used as a goal when the target mobile object that is the control target moves. It is possible to flexibly control movement in conformity with an actual movement environment by controlling the movement of the target mobile object using the information related to the goal trajectory.

The movement information may include information regarding a passage trajectory through which the other mobile object has passed. In this case, the first generation unit may generate the information related to the goal trajectory of the target mobile object on the basis of the passage trajectory of the other mobile object.

This makes it possible to flexibly control movement of the target mobile object in conformity with an actual movement environment on the basis of the passage trajectory of the other mobile object having passed through the actual movement environment.

The movement information may include identification information for identifying the other mobile object, and information regarding a passage point on the passage trajectory associated with the identification information.

This makes it possible to easily identify the other mobile object having passed through any spot, section, or the like, and easily acquire the passage trajectory or the like that is necessary for generating the information related to the goal trajectory.

The movement information may include surrounding information of the other mobile object detected at a timing of passing through the passage point.

By using the surrounding information of the other mobile object, it is possible to accurately identify the other mobile object having passed through a spot similar to the target mobile object.

The surrounding information may include at least one of image information or depth information of surroundings of the other mobile object.

By using the image information or the depth information, it is possible to identify the other mobile object having passed through a spot similar to the target mobile object, with sufficiently high accuracy.

The information processing apparatus may further include a second generation unit that generates a planned route from a current location of the target mobile object to a destination of the target mobile object.

This makes it possible to generate the information related to the goal trajectory tailored to the planned route to the destination of the target mobile object, and it is possible to automatically drive to the destination, for example.

The acquisition unit may acquire the movement information of the other mobile object having passed through a region including the current location of the target mobile object and a nearest route point on the planned route as viewed from the current location of the target mobile object.

This makes it possible to acquire movement information regarding a region that covers the nearest route point. As a result, it is possible to reduce communication load or the like that is necessary to acquire the movement information.

The first generation unit may generate information related to the goal trajectory from the current location of the target mobile object to a nearest route point on the planned route.

By setting a range of the goal trajectory to a range from the current location to the nearest route point, it is possible to sufficiently shorten time necessary to perform a process of generating the information related to the goal trajectory or the like.

The information processing apparatus may further include an extraction unit that extracts, from the movement information of the other mobile object acquired by the acquisition unit, reference movement information to be used for generating the information related to the goal trajectory. In this case, the first generation unit may generate the information related to the goal trajectory on the basis of the extracted reference movement information.

This makes it possible to improve accuracy of the goal trajectory. As a result, it is possible to flexibly and accurately control movement of the target mobile object in conformity with the actual movement environment.

The extraction unit may calculate a first correlation value that represents correlation between the planned route of the target mobile object and the passage trajectory of the other mobile object, and extract the reference movement information on the basis of the first correlation value.

This makes it possible to extract the other mobile object having passed a route correlated to the planned route of the target mobile object, and control movement of the target mobile object in conformity with an environment or the like of the planned route.

The extraction unit may extract the reference movement information on the basis of a distance between the current location of the target mobile object and a passage point on the passage trajectory of the other mobile object.

For example, this makes it possible to extract the other mobile object having passed near the current location of the target mobile object, and generate the information related to the goal trajectory for smoothly moving the target mobile object from the current location.

The extraction unit may calculate a second correlation value that represents correlation between surrounding information of the current location of the target mobile object and surrounding information of a passage point on the passage trajectory of the other mobile object, and extract the reference movement information on the basis of the second correlation value.

By correlating the pieces of surrounding information, it is possible to accurately extract the other mobile object having passed through a location similar to the current location of the target mobile object, and improve accuracy of the goal trajectory.

The extraction unit may calculate the second correlation value by comparing respective feature quantities of the surrounding information of the current location of the target mobile object and the surrounding information of the passage point of the other mobile object.

This makes it possible to easily compare the surrounding information of the target mobile object with the surrounding information of the other mobile object, and shorten time necessary for the generation process while improving accuracy of the goal trajectory.

The first generation unit may generate distribution information related to the passage trajectory of the other mobile object by using a predetermined distribution model, and generate the information related to the goal trajectory on the basis of the generated distribution information.

For example, this makes it possible to show trajectories through which other mobile objects have passed by using the distribution, and generate information related to a goal trajectory reflecting the trajectories in the actual movement environment.

The first generation unit may generate a cost map related to a movement cost of the target mobile object on the basis of the information related to the goal trajectory.

By using the cost map, it is possible to easily control movement of the target mobile object. This makes it possible to easily achieve flexible movement control.

The movement information may include information related to another goal trajectory that is a goal for movement of the other mobile object. In this case, the first generation unit may generate the information related to the goal trajectory of the target mobile object on the basis of information related to the other goal trajectory of the other mobile object.

By using the information related to the other goal trajectory of the other mobile object in such a way, it is possible to flexibly control movement of the target mobile object in conformity with the actual movement environment.

The information processing apparatus may further include: a third generation unit that generates information for movement of the target mobile object on the basis of map information; and a determination unit that determines whether it is possible for the third generation unit to execute a process of generating the information for movement of the target mobile object. In this case, the first generation unit may generate the information regarding the goal trajectory in the case where it is not possible for the third generation unit to execute the process of generating the information for movement of the target mobile object.

This makes it possible to flexibly control movement in accordance with the actual movement environment even in the case where it is not possible to control the movement on the basis of the map information, for example.

The information processing apparatus may be installed in the target mobile object. In this case, the acquisition unit may acquire the movement information from a server that is connected to the target mobile object and the other mobile object in such a manner that the server is capable of communicating with each of the target mobile object and the other mobile object via a network.

This makes it possible to easily acquire the movement information and the like that are necessary to control movement of the target mobile object, for example.

The information processing apparatus may be a server that is connected to the target mobile object and the other mobile object in such a manner that the server is capable of communicating with each of the target mobile object and the other mobile object via a network.

This makes it possible to quickly execute respective processes necessary to control movement of the target mobile object, for example.

The information processing apparatus may further include a transmission unit that transmits, to the target mobile object and via the network, the information related to the goal trajectory generated by the first generation unit.

This makes it possible to reduce load of communication between the server and the target mobile object, for example. As a result, it is possible to stably control movement.

A vehicle according to an embodiment of the present technology includes an acquisition unit, a first generation unit, and a movement control unit.

The acquisition unit acquires movement information related to movement of another vehicle different from an own vehicle that is a control target.

The first generation unit generates information related to a goal trajectory that is a goal for movement of the own vehicle on the basis of the acquired movement information of the other vehicle.

The movement control unit controls movement of the own vehicle on the basis of the generated information related to the goal trajectory.

A mobile object according to an embodiment of the present technology includes an acquisition unit, a first generation unit, and a movement control unit.

The acquisition unit acquires movement information related to movement of another mobile object different from a mobile object that is a control target.

The first generation unit that generates information related to a goal trajectory that is a goal for movement of the mobile object that is the control target, on the basis of the acquired movement information of the other mobile object.

The movement control unit that controls movement of the mobile object that is the control target on the basis of the generated information related to the goal trajectory.

An information processing method according to an embodiment of the present technology is an information processing method to be executed by a computer system, the information processing method including acquiring movement information related to movement of another mobile object different from a target mobile object that is a control target.

Information related to a goal trajectory that is a goal for movement of the target mobile object is generated on the basis of the acquired movement information of the other mobile object.

A program according to an embodiment of the present technology causes a computer system to execute a process including:

acquiring movement information related to movement of another mobile object different from a target mobile object that is a control target; and

generating information related to a goal trajectory that is a goal for movement of the target mobile object on the basis of the acquired movement information of the other mobile object.

### Advantageous Effects of Invention

As described above, according to the present technology, it is possible to flexibly control movement in conformity with an actual movement environment. Note that the effects described herein are not necessarily limited and may be any of the effects described in the present disclosure.

### BRIEF DESCRIPTION OF DRAWINGS

FIG. 1 is a schematic diagram illustrating a configuration example of a movement control system according to a first embodiment of the present technology.

FIG. 2 is a set of external views illustrating a configuration example of an automobile.

FIG. 3 is a block diagram illustrating the configuration example of the automobile.

FIG. 4 is a block diagram illustrating a functional configuration example of a trajectory generation apparatus.

FIG. 5 is a schematic diagram illustrating an example of a navigation image.

FIG. 6 is a schematic diagram illustrating a configuration example of movement information of the automobile.

FIG. 7 is a schematic diagram illustrating an example of a passage trajectory of the automobile.

FIG. 8 is a flowchart illustrating an example of controlling movement of the automobile.

FIG. 9 is a schematic diagram for describing an example of behavior of the trajectory generation apparatus.

FIG. 10 is a schematic diagram illustrating an example of surrounding information of a current location of an own vehicle.

FIG. 11 is a schematic diagram for describing a goal trajectory information generation example using distribution information.

FIG. 12 is a schematic diagram illustrating another example of goal trajectory information generated on the basis of distribution information.

FIG. 13 is a block diagram illustrating a functional configuration example of a trajectory generation apparatus according to a second embodiment.

FIG. 14 is a block diagram illustrating a functional configuration example of a trajectory generation apparatus according to a third embodiment.

### MODE(S) FOR CARRYING OUT THE INVENTION

Hereinafter, embodiments of the present technology will be described with reference to the drawings.

### First Embodiment

### [Configuration of Movement Control System]

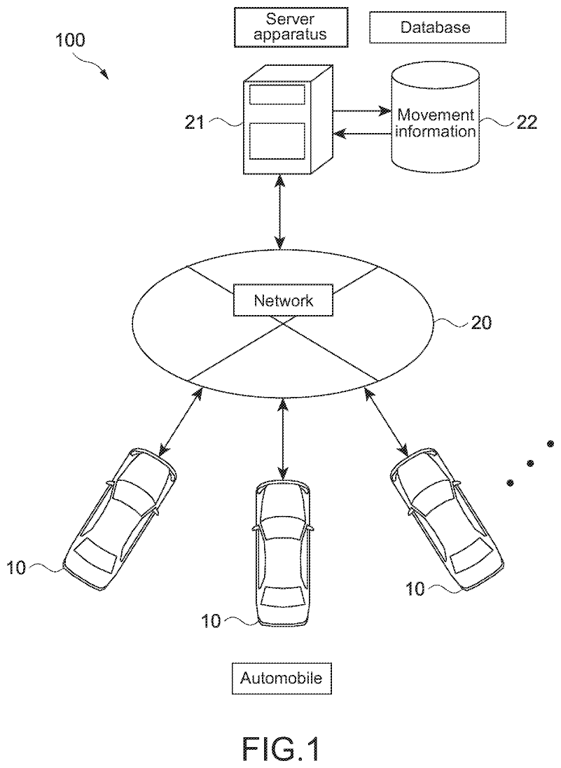

FIG. 1 is a schematic diagram illustrating a configuration example of a movement control system according to a first embodiment of the present technology. A movement control system 100 includes a plurality of automobiles 10, a network 20, a server apparatus 21, and a database 22. Each of the plurality of automobiles 10 has an autonomous driving function capable of automatically driving to a destination. Note that the automobiles 10 are examples of a mobile object according to the present embodiment.

The plurality of automobiles 10 and the server apparatus 21 are connected in such a manner that they are capable of communicating with each other via the network 20. The server apparatus 21 is connected to the database 22 in such a manner that the server apparatus 21 is capable of accessing the database 22. For example, the server apparatus 21 is capable of recording information from the plurality of automobiles 10 on the database 22 and transmitting the information recorded on the database 22 to each of the automobiles 10. According to the present embodiment, a so-called cloud service is provided by the network 20, the server apparatus 21, and the database 22. Therefore, it can be said that the plurality of automobiles 10 is connected to a cloud network. According to the present embodiment, the server apparatus 21 corresponds to a server.

[Configuration of Automobile]

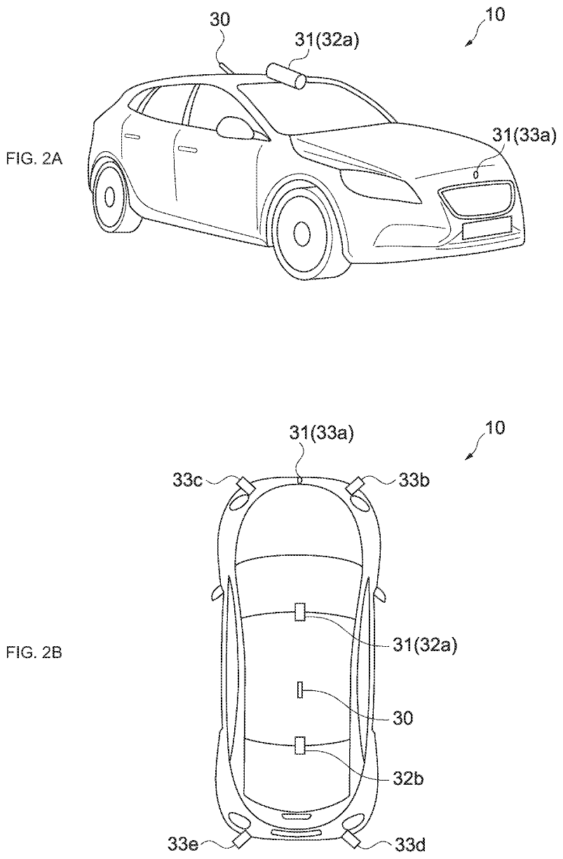

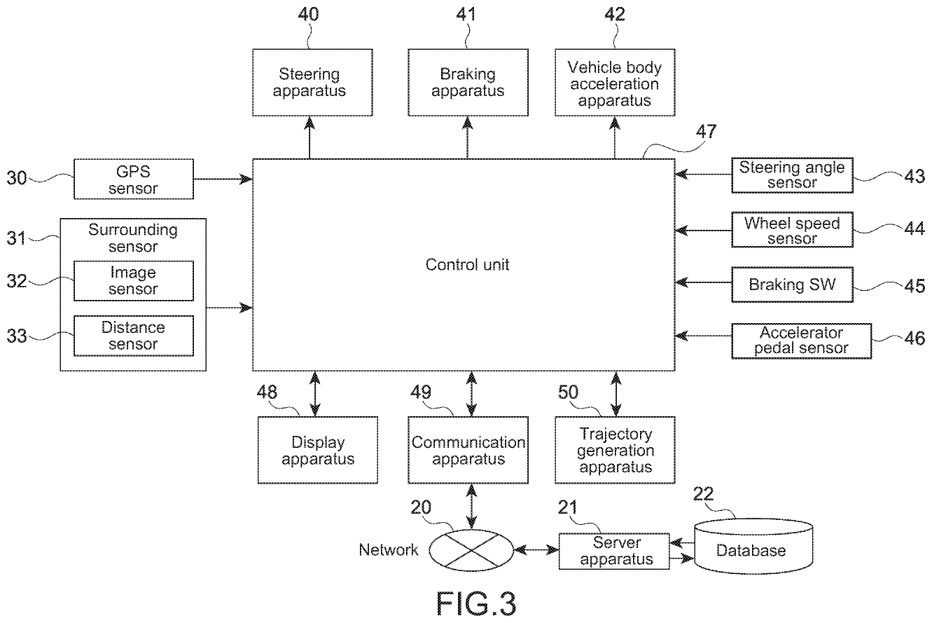

FIG. 2 is set of external views illustrating a configuration example of the automobile 10. A of FIG. 2 is a perspective view illustrating the configuration example of the automobile 10. B of FIG. 2 is a schematic diagram obtained when the automobile 10 is viewed from above. FIG. 3 is a block diagram illustrating the configuration example of the automobile 10.

As illustrated in A and B of FIG. 2, the automobile 10 includes a GPS sensor 30 and a surrounding sensor 31. In addition, as illustrated in FIG. 3, the automobile 10 includes a steering apparatus 40, a braking apparatus 41, a vehicle body acceleration apparatus 42, a steering angle sensor 43, a wheel speed sensor 44, a braking switch 45, an accelerator pedal sensor 46, a control unit 47, a display apparatus 48, a communication apparatus 49, and a trajectory generation apparatus 50.

The GPS sensor 30 detects a current value of the automobile 10 on the earth by receiving a radio wave from a satellite. Information regarding the current value is typically detected as information regarding latitude and longitude of a location of the automobile 10. The information regarding the detected current value is output to the control unit.

The surrounding sensor 31 is a sensor that detects surrounding information of the automobile 10. Here, the surrounding information is information including image information and depth information of surroundings of the automobile 10. As illustrated in FIG. 3, the surrounding sensor 31 includes an image sensor 32 and a distance sensor 33.

The image sensor 32 captures an image of the surroundings of the automobile 10 at a predetermined frame rate, and detects the image information of the surroundings of the automobile 10. A and B of FIG. 2 illustrate a front camera 32a and a rear camera 32b as the image sensor 32. The front camera 32a captures an image of a field of view of a front side of the automobile 10. The rear camera 32b captures an image of a field of view of a rear side of the automobile 10.

For example, an RGB camera or the like is used as the image sensor 32. The RGB camera includes an image sensor such as a CCD or a CMOS. The present technology is not limited thereto. It is also possible to appropriately use an image sensor or the like that detects infrared light or polarized light. By using the infrared light or polarized light, it is possible to generate image information or the like whose visibility is not changed so much even in the case where weather has changed, for example.

The distance sensor 33 is installed in such a manner that the distance sensor 33 faces toward the surroundings of the automobile 10, for example. The distance sensor 33 detects information related to distances to objects included in its detection range, and detects depth information of the surroundings of the automobile 10. A and B of FIG. 2 illustrate distance sensors 33a to 33e that are respectively installed on the front side, the right front side, the left front side, the right rear side, the left rear side of the automobile 10. For example, by using the distance sensor 33a installed on the front side of the automobile 10, it is possible to detect a distance to a vehicle running in front of the automobile 10, or the like.

For example, a Laser Imaging Detection and Ranging (LiDAR) sensor or the like is used as the distance sensor 33. By using the LiDAR sensor, it is possible to easily detect an image (depth image) with depth information or the like, for example. Alternatively, for example, it is also possible to use a Time-of-Fright (TOF) depth sensor or the like as the distance sensor 33. The type and the like of the distance sensor 33 are not limited. It is possible to use any sensor using a rangefinder, a millimeter-wave radar, an infrared laser, or the like.

Note that the GPS sensor 30 and the surrounding sensor (the image sensor 32 and the distance sensor 33) may be configured in such a manner that their output is supplied to the trajectory generation apparatus 50 instead of the control unit 47 as illustrated in FIG. 3.

The steering apparatus 40 typically includes a power steering apparatus, and transmits steering wheel operation performed by a driver to driving wheels. The braking apparatus 41 includes brake actuators attached to respective wheels and hydraulic circuits for actuating them, and controls braking force of the respective wheels. The vehicle body acceleration apparatus 42 includes a throttle valve, a fuel injector, and the like, and controls rotational acceleration of the driving wheels.

The steering angle sensor 43 detects change in steering angle of a steering wheel, directions of wheels depending on steering, and the like. The wheel speed sensor 44 is installed in some or all of the wheels and detects rotation speed and the like of the wheels. The accelerator pedal sensor 46 detects an operation amount or the like of an accelerator pedal. Note that the steering angle sensor 43, the wheel speed sensor 44, and the accelerator pedal sensor 46 are capable of detecting states of the steering wheel, the wheels, the accelerator pedal, and the like and outputting the states to the control unit 47 not only in the case where the driver drives the automobile 10 but also in the case of automatically driving the automobile 10.

The braking switch 45 is for detecting braking operation (depression of the brake pedal) performed by the driver, and is referred to at the time of ABS control or the like. In addition, it is also possible to install any sensor that detects behavior of respective structural elements of the automobile 10.

The control unit 47 controls movement of the automobile 10 on the basis of goal trajectory information output from the trajectory generation apparatus 50 (to be described later). Specifically, the control unit 47 achieves autonomous driving including autonomous obstacle avoidance by proactively controlling the respective apparatuses on the basis of the goal trajectory information and output from the surrounding sensor 31. According to the embodiment, the control unit 47 corresponds to a movement control unit.

Note that the control unit 47 may of course control the steering apparatus 40, the braking apparatus 41, and the vehicle body acceleration apparatus 42 individually, or the control unit 47 may perform cooperative control of at least two out of these apparatuses. This makes it possible to control the automobile 10 in such a manner that the automobile 10 has a desired posture at the time of steering (turning), braking, acceleration, or the like.

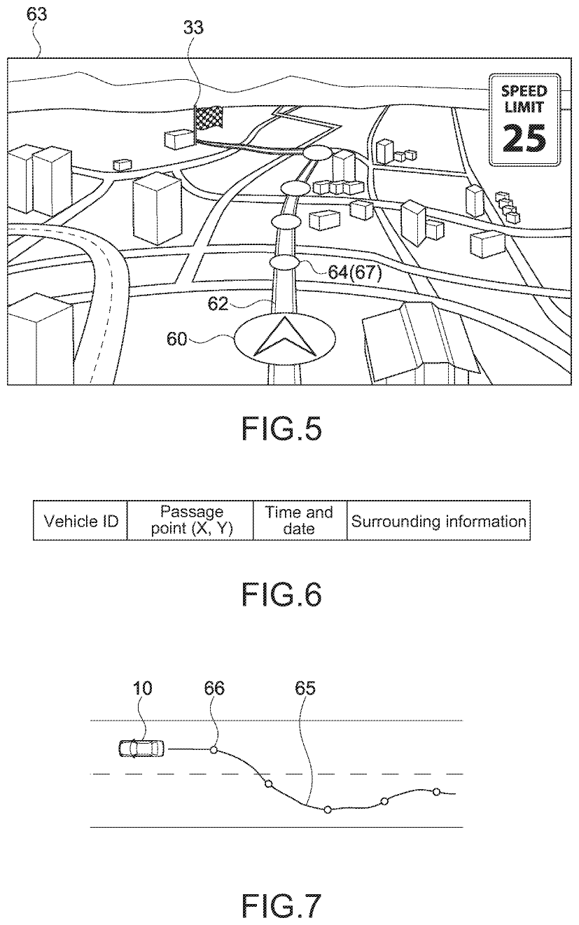

The display apparatus 48 includes a display unit that uses liquid crystals, electroluminescence (EL), or the like, for example. The display apparatus 48 displays a planned route of the automobile 10 output from the trajectory generation apparatus 50, a current location of the automobile 10, and a navigation image (see FIG. 5) including surrounding map information or the like. This makes it possible to provide a car navigation service. In addition, it is also possible to use an apparatus for displaying an augmented reality (AR) image at a predetermined position such as a front windshield. In addition, a specific configuration of the display apparatus 48, the type of displayed information, and the like are not limited.

The communication apparatus 49 performs wireless communication for connecting to the network 20. In addition, the communication apparatus 49 is configured to be capable of accessing the database 22 via the network 20 and the server apparatus 21. For example, the communication apparatus 49 appropriately downloads data from the database 22, and uploads data to the database 22, for example.

For example, a wireless communication module for a mobile object capable of wireless local area network (LAN) communication using Wi-Fi or the like, cellular communication such as Long-Term Evolution (LTE), or the like is appropriately used as the communication apparatus 49. In addition, a specific configuration of the communication apparatus 49 is not limited. For example, it is possible to use any communication apparatus 49 capable of connecting to the network 20.

The trajectory generation apparatus 50 is used for controlling movement of the automobile 10 including the trajectory generation apparatus 50. Therefore, a movement control target of the trajectory generation apparatus 50 is the automobile including the trajectory generation apparatus 50. On the other hand, other automobiles that do not include the trajectory generation apparatus 50 are other automobiles that are different from the control target. According to the present embodiment, the automobile 10 of the control target corresponds to a target mobile object that is the control target. In addition, the other automobiles 10 correspond to other mobile objects that are different from the target mobile object.

The trajectory generation apparatus 50 generates goal trajectory information for moving the automobile 10 on the basis of information uploaded to the database 22 by the other automobiles 10. Details of the trajectory generation apparatus 50 will be described later. According to the present embodiment,

The trajectory generation apparatus 50 corresponds to an information processing apparatus according to the present embodiment, and includes hardware necessary for a computer such as a CPU, RAM, and ROM, for example. A trajectory generation method (an information processing method) according to the present technology is executed when the CPU loads a program into the RAM and executes the program. The program relates to the present technology and is recorded on the ROM in advance.

The specific configuration of the trajectory generation apparatus 50 is not limited. For example, it is possible to use a programmable logic device (PLD) such as a field programmable gate array (FPGA), or another device such as an application specific integrated circuit (ASIC). In addition, the trajectory generation apparatus 50 may be configured as a part of the control unit 47.

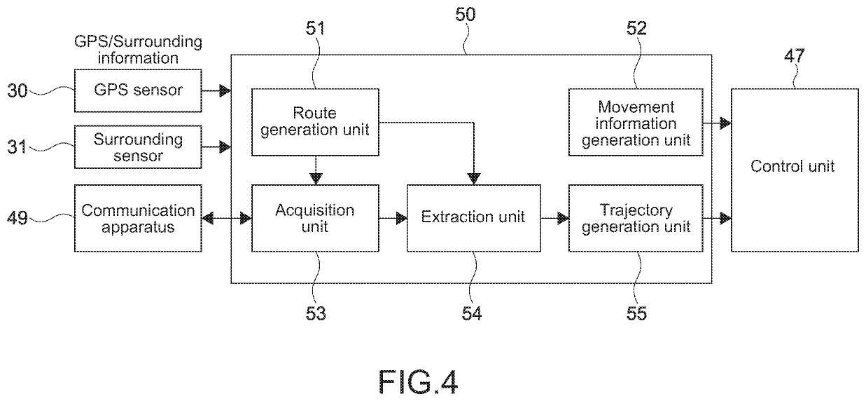

FIG. 4 is a block diagram illustrating a functional configuration example of the trajectory generation apparatus 50. The trajectory generation apparatus 50 includes a route generation unit 51, a movement information generation unit 52, an acquisition unit 53, an extraction unit 54, and a trajectory generation unit 55. For example, each of the functional blocks is configured when the CPU of the trajectory generation apparatus 50 executes a predetermined program. In addition, as illustrated in FIG. 3, respective outputs from the GPS sensor 30, the surrounding sensor 31, and the communication apparatus 49 are supplied to the trajectory generation apparatus 50 via the control unit 47.

The route generation unit 51 generates a planned route from a current location of the automobile 10 to a destination of the automobile 10. A planned route 62 is information indicating a way (a path) from the current location to the destination. Typically, the planned route 62 is information for designating roads included in the map information. Accordingly, the planned route 62 designates roads or the like the automobile 10 should follow to get the destination from the current location.

The current location of the automobile 10 is current latitude and longitude of the automobile 10 detected by the GPS sensor 30, for example. In addition, for example, the driver or the like inputs the destination of the automobile 10 by using an input apparatus (not illustrated) or the like. The planned route generated by the route generation unit 51 is output to the acquisition unit 53 and the extraction unit 54. In addition, the route generation unit 51 generates a navigation image including the planned route, and outputs the generated navigation image to the display apparatus 48. According to the embodiment, the route generation unit 51 corresponds to a second generation unit.

FIG. 5 is a schematic diagram illustrating an example of the navigation image. The example illustrated in FIG. 5 schematically illustrates a navigation image 63 including a current location 60, a destination 61, and a planned route 62 of the automobile 10, and map information of surroundings of the planned route 62. In addition, on the planned route 62, a plurality of route points 64 is displayed. The automobile 10 will pass through the plurality of route points 64. Note that the planned route 62 does not include information indicating which position the automobile 10 should drive on a road to be traveled.

The movement information generation unit 52 generates movement information related to movement of the automobile 10 including the movement information generation unit 52. According to the present embodiment, information related to a passage trajectory through which the automobile 10 has passed is generated as the movement information.

FIG. 6 is a schematic diagram illustrating a configuration example of the movement information of the automobile 10. FIG. 7 is a schematic diagram illustrating an example of the passage trajectory of the automobile 10. FIG. 7 schematically illustrates a passage trajectory 65 of the automobile 10 that has changed its lane on a road having two lanes each way. Next, details of the movement information (information related to the passage trajectory 65) of the automobile 10 will be described with reference to FIG. 6 and FIG. 7.

The automobile 10 detects a current location of the automobile 10 that is in operation (such as running or at a stop) at predetermined time intervals by using the GPS sensor 30 installed in the automobile 10. As illustrated in FIG. 7, current locations of the automobile 10 detected at respective timings are passage points 66 on the passage trajectory 65 of the automobile 10.

The movement information generation unit 52 generates, as the movement information, information in which a vehicle ID of the automobile 10 and information regarding the passage points 66 (latitude X and longitude Y) are associated. At this time, times and dates at which the automobile 10 has passed through the passage points 66 or the like are recoded on the movement information. According to the present embodiment, the vehicle ID corresponds to identification information.

In addition, the movement information generation unit 52 generates the movement information while associating the passage points 66 with their surrounding information (such as image information and depth information) detected when the automobile 10 has passed through the passage points 66. Therefore, as illustrated in FIG. 6, the movement information of the automobile 10 includes the vehicle ID of the automobile 10, the passage points 66, the times and dates, the surrounding information of the passage points 66, and the like.

Note that the surrounding information is detected by the surrounding sensor 31 at a timing at which the automobile 10 passes through each of the passage points 66. For example, the image sensor such as the front camera 32a and the rear camera 32b detects image information of the front side, the rear side, and the like of the automobile 10 when the automobile 10 passes through the passage point 66. In addition, the distance sensor 33 such as the LiDAR sensor detects depth information of the surroundings of the automobile 10.

For example, a form such as movement information A=(vehicle ID, time and date, latitude and longitude of passage point 66, data of sensor 1, data of sensor 2, . . . , and data of sensor N) is used as the form of movement information. Note that data of the sensor 1 to the sensor N corresponds to data detected by the image sensor 32 or the distance sensor 33 mounted on each structural element of the automobile 10. As described above, by making the data form in which pieces of data are assembled for each passage point 66, it is possible to easily search for movement information A, for example. Alternatively, the form and the like of the movement information are not limited. It is possible to use any form.

The generated movement information of the automobile 10 is output to the communication apparatus 49 via the control unit 47. The communication apparatus 49 appropriately uploads the movement information of the automobile 10 to the database 22. A timing and the like of the upload are not limited. For example, it is possible to upload the movement information immediately after the automobile 10 passes through the passage point 66. Alternatively, for example, it is possible to upload a set of pieces of movement information related to the plurality of passage points 66 in accordance with a communication situation or the like.

As described with reference to FIG. 1, the database 22 stores therein movement information from a plurality of automobiles 10. In other words, the database 22 collects information regarding passage trajectories 65 through which the respective automobiles 10 have passed. As a result, for example, it is possible to search for an automobile 10 (a vehicle ID) or the like having passed through a certain region by searching for movement information in which the certain region includes a passage point 66. In addition, it is also possible to search for a history (the passage trajectory 65) or the like of the passage points 66 on the road through which the automobile 10 has passed, on the basis of the vehicle ID or the time and date.

Returning to FIG. 4, the acquisition unit 53 acquires movement information related to movement of other automobiles 10 that are different from the automobile 10 of the control target. Specifically, the acquisition unit 53 accesses the database 22 via the server apparatus 21, and acquires movement information of the other automobiles 10 stored in the database 22. In other words, it can be said that the acquisition unit 53 acquires the movement information from the server apparatus 21 connected to the automobile 10 and the other automobiles 10 in such a manner that the acquisition unit 53 is capable of communicating with each of the automobile 10 of the control target and the other automobiles 10 via the network.

The movement information of the other automobile 10 is information generated by a movement generation unit 52 (a trajectory generation apparatus 50) included in the other automobile 10, and includes information regarding a passage trajectory 65 through which the other automobile 10 has passed. For example, the acquisition unit 53 appropriately searches the database 22 and acquires the information regarding the passage trajectory 65 of the other automobile 10 necessary for controlling movement of the automobile 10.

The extraction unit 54 extracts reference movement information to be used for generating the goal trajectory information from the movement information of the other automobile 10 acquired by the acquisition unit 53. The reference movement information is extracted in such a manner that it is possible to generate the goal trajectory information with a desired accuracy, for example. As described later, the extraction unit 54 extracts the reference movement information on the basis of the current location 60 of the automobile 10, the surrounding information of the current location 60, information regarding the planned route 62 of the automobile 10, or the like.

The trajectory generation unit 55 generates goal trajectory information related to a goal trajectory that is a goal for movement of the automobile 10 on the basis of the movement information of the other automobiles 10 acquired by the acquisition unit 53. Here, the goal trajectory is a trajectory the automobile 10 should follow under the movement control. In other words, it can be said that the goal trajectory information is information (a trajectory plan) in which a trajectory the automobile 10 should follow is planned. According to the present embodiment, the trajectory generation unit 55 corresponds to a first generation unit.

The goal trajectory information includes information that designates a location that is a goal for movement on a road through which the automobile 10 travels, for example. Therefore, it can be said that the goal trajectory information is information capable of designating more accurate locations than the above-described planned route 62. According to the present embodiment, the trajectory generation unit 55 generates the goal trajectory information on the basis of reference movement information extracted by the extraction unit 54.

In addition, the trajectory generation unit 55 generates a cost map related to a movement cost of the automobile 10 on the basis of the goal trajectory information. In the cost map, a high movement cost is set for a region including, for example, an obstacle such as a traffic barrier or a median strip, a region where it is difficult to drive, and the like. Conversely, a low movement cost is set for a region where it is possible to drive along a middle of a lane or the like. The generated cost map (goal trajectory information) is output to the control unit 47.

[Control of Movement of Automobile]

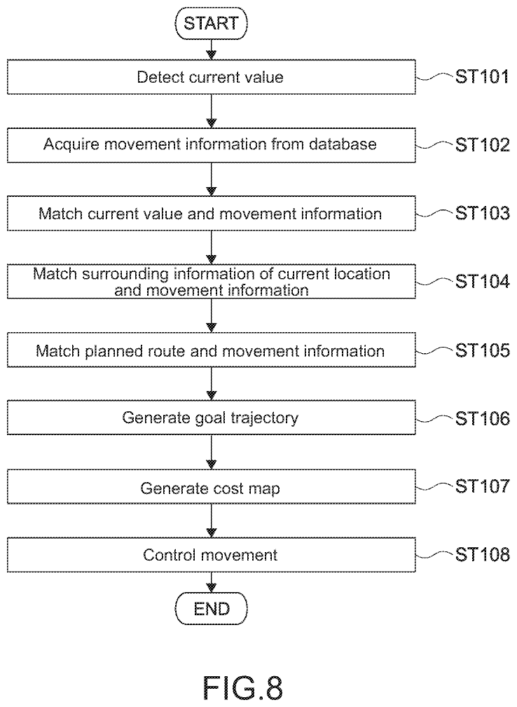

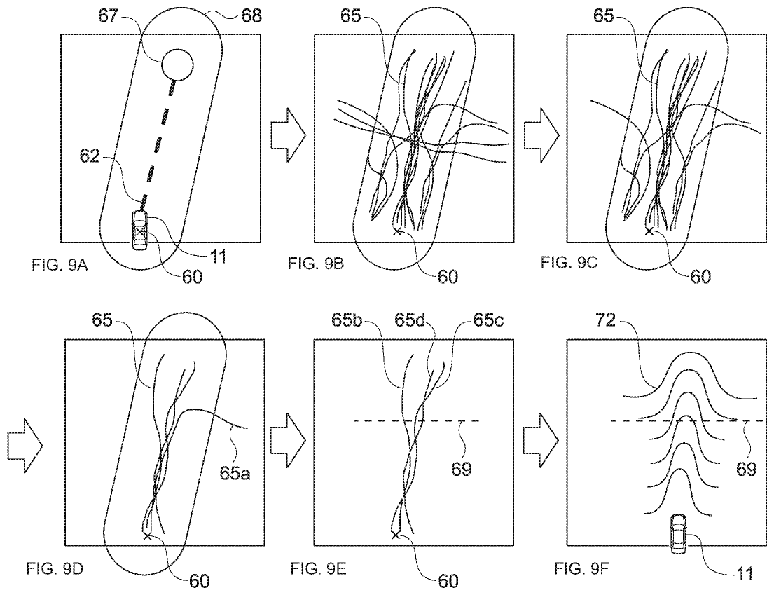

FIG. 8 is a flowchart illustrating an example of controlling movement of the automobile 10. FIG. 9 is a schematic diagram for describing an example of behavior of the trajectory generation apparatus 50. Hereinafter, the automobile 10 of a movement control target is referred to as an own vehicle 11, and the other automobiles 10 are referred to as other vehicles 12.

As illustrated in FIG. 8, the GPS sensor 30 detects the current location 60 of the own vehicle 11 (Step 101). The current location 60 of the own vehicle 11 is output to the trajectory generation apparatus 50.

The acquisition unit 53 acquires movement information of the other vehicles 12 from the database 22 on the network 20 (Step 102).

As described with reference to FIG. 6, the movement information of the other vehicles 12 includes vehicle IDs for identifying the other vehicles 12 and information regarding the passage points 66 on the passage trajectories 65 associated with the vehicle IDs. In addition, the movement information of the other vehicles 12 includes surrounding information of the other vehicles 12 detected at the timings of passing through the passage points 66. The surrounding information includes image information and depth information of the surroundings of the other vehicles 12 obtained when passing through the passage points 66. As described above, it can be said that the acquisition unit 53 acquires driving history data in which respective pieces of information detected while the other vehicles 12 have been travelling are recorded.

According to the present embodiment, the acquisition unit 53 acquires the movement information of the other vehicles 12 having passed through a region including the current location 60 of the own vehicle 11 and a nearest route point 67 on the planned route 62 as viewed from the current location 60 of the own vehicle 11. The nearest route point 67 on the planned route 62 is a route point 64 on the destination side, the route point 64 being closest to the current location 60 of the own vehicle 11 (see FIG. 5).

For example, it is assumed that each interval between the route points 64 on the planned route 62 is set to 100 m. In this case, a distance from the current location to the nearest route point 67 is 100 m or less. Of course, the intervals are not limited thereto. For example, it is possible to appropriately set intervals between the route points 64 in accordance with an actual traffic situation, communication environment, processing speed, or the like. For example, it is possible to set the intervals between the route points 64 on the planned route 62 in a range from several meters to several kilometers. In addition, it is also possible to set the nearest route point 67 as a point at which the own vehicle 11 is capable of arriving after a predetermined period of time elapses. In other words, the intervals between the route points 64 may be set on the basis of speed of the own vehicle 11, time necessary to pass, or the like.

The acquisition unit 53 sets a to-be-passed region 68 including the current location 60 of the own vehicle 11 and the nearest route point 67. (a) of FIG. 9 schematically illustrates the current location 60 of the own vehicle 11, the nearest route point 67, and the to-be-passed region 68. A method of setting the to-be-passed region 68 or the like is not limited. For example, it is possible to appropriately set the to-be-passed region 68 in accordance with the width of a road through which the own vehicle 11 travels, surrounding traffic volume, and the like.

The acquisition unit 53 transmits an instruction to the server apparatus 21 via the communication apparatus 49. The instruction instructs to search for movement information of the other vehicles 12 having passed through the to-be-passed region 68 within a predetermined period of time. For example, the server apparatus 21 searches the database 22 for movement information that includes a passage point 66 in the to-be-passed region 68 and that has been generated within the predetermined period of time, and transmits the movement information that satisfies the above-described conditions to the acquisition unit 53 (the communication apparatus 49).

The predetermined period of time is set to a period including several hours before current time, for example. This makes it possible to acquire movement information of the other vehicle 12 having passed immediately before passage of the own vehicle 11. Of course, it is possible to set the period to past half a day, past several days, or the like. Alternatively, it is possible to designate a period in such a manner that a time slot in a day is designated to search for movement information obtained within last several days. In addition, the method of setting the predetermined period of time is not limited.

(b) of FIG. 9 schematically illustrates passage trajectories 65 related to the movement information acquired by the acquisition unit 53, that is, passage trajectories 65 of the other vehicles 12 having passed through the to-be-passed region 68. Note that, at this time, movement information corresponding to passage trajectories 65 (passage points 66) that are out of the to-be-passed region 68 is not acquired.

The extraction unit 54 extracts reference movement information from the movement information acquired by the acquisition unit 53 (Step 103 to Step 105). According to the present embodiment, the reference movement information is extracted by executing the three-staged extraction process in Step 103 to Step 105. Each of (c) to (e) of FIG. 9 illustrates passage trajectories 65 related to the reference movement information (first reference movement information to third reference movement information) extracted in Step 103 to Step 105.

In Step 103, the extraction unit 54 compares the current location 60 of the own vehicle 11 with the passage points 66 included in the movement information, and extracts the first reference movement information (Step 103). According to the present embodiment, the first reference movement information is extracted on the basis of distances between the current location of the own vehicle 11 and the passage points 66 on the passage trajectories 65 of the other vehicles 12.

For example, a distance between the current location and the passage point 66 is calculated from latitude and longitude of the current location 60 and latitude and longitude of the passage point 66. It is determined whether the calculated distance is smaller than a preset distance threshold. The passage point 66 whose distance to the current location 60 is smaller than the distance threshold is determined to be a passage point 66 that is close to the current location 60. Movement information of another vehicle 12 having passed through the passage point 66 determined to be close to the current location 60 is extracted as the first reference movement information.

This makes it possible to specify the other vehicle 12 (the passage trajectory 65) having passed near the current location 60. In addition, for example, it is possible to exclude other vehicles 12 or the like having passed through the to-be-passed region 68 in such a manner that passage trajectories of the other vehicles 12 intersect with the planned route 62 (See (b) of FIG. 9).

The distance threshold is appropriately set in such a manner that it is possible to extract the first reference movement information with a desired accuracy, for example. For example, it is also possible to set the distance threshold in accordance with the width of a road through which the own vehicle 12 is traveling, the number of lanes, or the like. This makes it possible to accurately extract the other vehicles 12 having passed through the same road. Note that it is also possible to execute a process of picking up a predetermined number of other vehicles 12 in ascending order of distance to the current location 60 without using the distance threshold.

In addition, the present technology is not limited to the case of comparing the current location 60 with the passage points 66. For example, it is also possible to compare latitude and longitude of the nearest route point 67 with latitudes and longitudes of the passage points 66. This makes it possible to specify the other vehicles 12 having passed near the nearest route point 67.

In Step 104, the second reference movement information is extracted by comparing surrounding information of the current location 60 of the own vehicle 11 with surrounding information of the other vehicles 12 detected at the timings of passing through the passage points 66. According to the present embodiment, correlation values that are related to surrounding information and that represent correlation between the surrounding information of the current location 60 of the own vehicle 11 and the surrounding information of the passage points 66 on the passage trajectories 65 of the other vehicles 12 are calculated, and the second reference movement information is extracted on the basis of the correlation values related to the surrounding information. According to the present embodiment, the correlation value related to the surrounding information corresponds to a second correlation value.

Typically, the correlation value related to the surrounding information is calculated with regard to pieces of surrounding information of the same type. For example, a process of comparing image information that captures a front side of the own vehicle 11 with image information that captures a front side of another vehicle 12 and calculating a correlation value is executed. In addition, for example, in the case where the surrounding information has the form such as (data of sensor 1, data of sensor 2, . . . , and data of sensor N) as described above, a correlation value of pieces of data of the same sensor is calculated. Note that the correlation value is an index representing a degree of similarity between pieces of surrounding information (image information, depth information, or the like) to be compared.

In addition, the correlation values related to the surrounding information are calculated by comparing respective feature quantities of the surrounding information of the current location 60 of the own vehicle 11 and the surrounding information of the passage points 66 of the other vehicles 12. For example, image information (depth information) detected at the current location 60 of the own vehicle 11 is converted into information of a feature space represented by a predetermined feature quantity. In a similar way, image information (depth information) detected at the passage point 66 of the other vehicle 12 is converted into information of the feature space represented by a predetermined feature quantity. A distance S between the respective pieces of information converted into the feature quantities in the feature space is calculated as the correlation value related to the surrounding information.

The distance S in the feature space gets larger as values of the respective feature quantities of the own vehicle 11 and the other vehicle 12 are far from each other. In other words, it can be said that a degree of similarity between the respective pieces of surrounding information of the own vehicle 11 and the other vehicle 12 becomes lower (correlation becomes lower) as the distance S in the feature space gets larger. Therefore, it can also be said that the distance in the feature space is an index representing a degree of unlikeness between pieces of surrounding information.

It is possible to represent the calculation of the distance S in the feature space by using the following equation:

S=dist(Φ(A), Φ(Bn))

where A represents surrounding information of the current location 60 of the own vehicle 11, and Bn represents surrounding information of another n-th vehicle 12. In addition, Φ( ) is a mathematical function for calculating a predetermined feature quantity, that is, a mathematical function for performing conversion into a feature space. dist( ) is a mathematical function depending on the predetermined feature quantity, the mathematical function calculating the distance S in the feature space represented by the predetermined feature quantity.

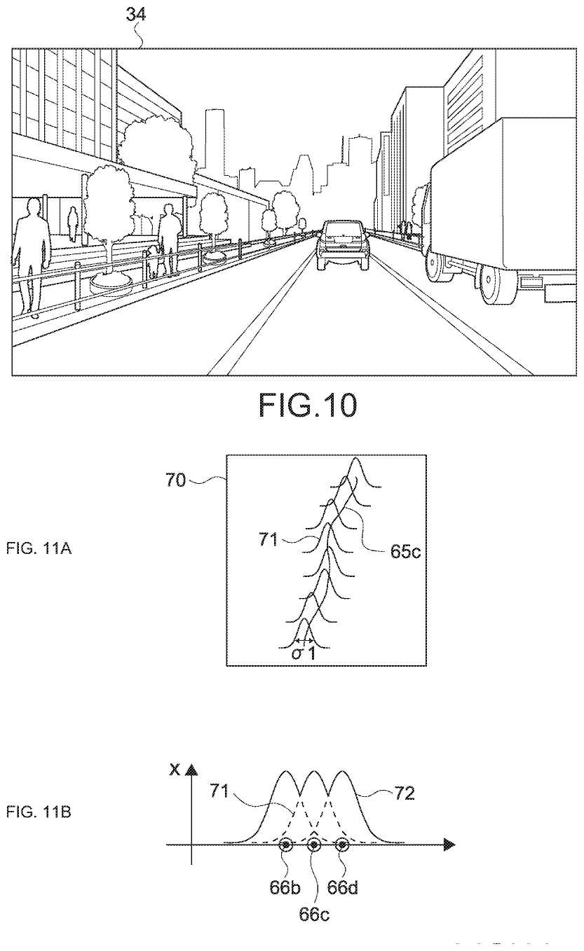

FIG. 10 is a schematic diagram illustrating an example of the surrounding information of the current location 60 of the own vehicle 11. FIG. 10 schematically illustrates an image 34 captured by the front camera 32a of the own vehicle 11. Note that the image 34 (image information) that is actually captured is typically an RGB image (color image).

A process of calculating a simple Euclidean distance between the RGB image of the own vehicle 11 and the RGB image of the other vehicle 12 is considered as a process of calculating the distance S in the feature space. In this case, Φ( ) is an identity function, and the RGB values of the pieces of image information are calculated as they are. In addition, dist( ) is a mathematical function of calculating a square error of the RGB values for each pixel. This makes it possible to determine whether the RGB values of each pixel are similar. In addition, it is possible to suppress an amount of the calculation because Φ( ) is the identity function.

In addition, a process of calculating an inter-histogram distance of the RGB values is considered as the process of calculating the distance S in the feature space. In this case, Φ( ) is a mathematical function of calculating a histogram of the RGB values of the image information, and dist( ) is a mathematical function of calculating a distance between histograms. This makes it possible to appropriately compare images even in the case where the images have different brightness or the like, for example. In addition, it is also possible to calculate feature quantities such as outlines, corners, and the like of roads, buildings, and the like as feature quantities of the image information.

In the case of using the depth information, the depth information is appropriately converted into three-dimensional feature quantity or the like that represents a feature of a point cloud or the like. Subsequently, the distance S in a feature space related to the converted feature quantity is calculated. The depth information does not change so much depending on weather, time slots, or the like in comparison with the image information, for example. Therefore, by comparing feature quantities of the depth information, it is possible to appropriately calculate correlation between pieces of information detected in different weather or different time slots.

In addition, the type and the like of the surrounding information used for extracting the second reference movement information are not limited. For example, instead of the RGB images, it is possible to use output from a sensor or the like that detects infrared light or polarized light. In addition, it is also possible to execute a process of selecting or adding a type of surrounding information to be compared, in accordance with a situation such as weather or a time slot. For example, it is possible to execute a process of flexibly selecting a sensor in accordance with situations in such a manner that, in the event of rain or cloudy weather, output from a sensor that is dedicated to such weather is used. This makes it possible to appropriately compare pieces of surrounding information.

The extraction unit 54 compares the calculated distance S in the feature space with a feature quantity threshold corresponding to feature quantity. Movement information of another vehicle 12 that has detected its surrounding information is extracted as the second reference movement information in the case where the distance S in the feature space is determined to be smaller than the preset feature quantity threshold (in the case where the distance S has high correlation to the preset feature quantity threshold). This makes it possible to specify the other vehicle 12 that has detected image information or depth information that has high correlation to the surrounding information of the current location 60 of the own vehicle 11. As a result, it is possible to accurately extract the other vehicle 12 having passed through a position (passage point 66) similar to the current location 60 of the own vehicle 11.

Note that the feature quantity threshold is set in accordance with the type or the like of the feature quantity used for the comparison. A method of setting the feature quantity threshold is not limited. The feature quantity threshold is appropriately set in such a manner that it is possible to extract the reference movement information with a desired accuracy. Note that it is also possible to execute a process of picking up a predetermined number of other vehicles 12 in ascending order of the distance S in the feature space without using the feature quantity threshold. In addition, any method that uses machine learning or the like may be used as a process of calculating correlation between pieces of surrounding information of the own vehicle 11 and other respective vehicles 12.

Returning to FIG. 8, the planned route 62 of the own vehicle 11 is compared with the passage trajectories 65 of the other vehicles 12, and the third reference movement information is extracted (Step 105). According to the present embodiment, correlation values related to trajectories that represent correlation between the planned route 62 of the own vehicle 11 and the passage trajectories 65 of the other vehicles 12 are calculated, and the third reference movement information is extracted on the basis of the correlation values related to the trajectories. According to the present embodiment, the correlation value related to the trajectory corresponds to the first correlation value.

It is possible to represent the planned route 62 of the own vehicle 11 as series information of respective locations (latitudes and longitudes) on the planned route 62. In a similar way, it is possible to represent the passage trajectory 65 of the other vehicle 12 as series information of the passage points 66 on the passage trajectory 65. The extraction unit 54 calculates an inter-series distance as a correlation value related to the trajectory by appropriately calculating distances between the respective locations on the planned route 62 and the passage points 66 on the passage trajectory 65. For example, a degree of similarity (correlation) between the planned route 62 and the passage trajectory 65 becomes high when the inter-series information is small.

According to the present embodiment, information regarding a next passage point 66 after the passage trajectory 65 that has already been acquired is acquired, and the passage trajectory 65 is extended by a predetermined distance. For example, with regard to a passage trajectory 65a illustrated in (d) of FIG. 9, information regarding a passage point 66 or the like outside the to-be-passed region 68 is acquired. The extraction unit 54 calculates an inter-series distance to the planned route 62 on the basis of the extended passage trajectory 65. By extending the passage trajectory 65 as described above, it is possible to determine whether the planned route 62 is similar to the passage trajectory 65, with high accuracy.

The extraction unit 54 extracts, as the third reference movement information, movement information of the other vehicle 12 having passed through the passage trajectory 65. An inter-series distance of a passage trajectory 65 is smaller than a threshold related to a predefined trajectory. As a result, for example, the passage trajectory 65a illustrated in (d) of S is excluded because the passage trajectory 65a have small correlation to the planned route 62. As a result, it is possible to specify another vehicle 12 that has traveled along the planned route 62 of the own vehicle 11.

The extension distance of the passage trajectory 65 and the value of the threshold related to the trajectory are not limited. For example, they are appropriately set in such a manner that it is possible to extract the third reference movement information with a desired accuracy. In addition, it is also possible to execute a process of picking up N number of other vehicles 12 in ascending order of the inter-series distance without using the threshold related to the trajectory. In addition, the process of calculating the correlation between the planned route 62 and the passage trajectory 65 is not limited. For example, it is possible to use any method such as cluster analysis or machine learning.

Note that the order or the like of Step 103 to Step 105 is not limited. By executing the three-staged extraction process as described above, it is possible to accurately extract the reference movement information, and it is possible to improve accuracy of the goal trajectory information. In addition, the specific method and the like of the extraction process performed by the extraction unit 54 are not limited. For example, it is possible to execute any one or two of Step 103 to Step 105. Of course, it is possible to use another method of extracting the reference movement information.

The trajectory generation unit 55 generates the goal trajectory information (Step 106). According to the present embodiment, goal trajectory information is generated from the current location 60 of the own vehicle 11 to the nearest route point 67 on the planned route 62.

The trajectory generation unit 55 generates distribution information related to the passage trajectories 65 of the other vehicles 12 by using a predetermined distribution model, and generates the goal trajectory information on the basis of the generated distribution information. Here, the distribution information is information generated by distributing the passage trajectories 65 using a distribution function that is the predetermined distribution model. In the distribution information, surroundings of the passage trajectories 65 are provided with distribution values depending on the distribution function. The distribution values make it possible to represent probabilities of passage of the other vehicles 12 as described later.

FIG. 11 is a schematic diagram for describing a goal trajectory information generation example using the distribution information. A of FIG. 11 is a schematic diagram illustrating an example of distribution information 70. B of FIG. 11 is a schematic diagram illustrating an example of goal trajectory information generated on the basis of the distribution information 70. B of FIG. 11 schematically illustrates passage points 66b to 66d at which the three passage points 65b to 65d illustrated in (e) of FIG. 9 intersect with a dotted line 69 illustrated in (e) of FIG. 9.

A of FIG. 11 schematically illustrates, as an example, distribution information regarding a passage trajectory 65c illustrated in (e) of FIG. 9. Here, a Gaussian distribution function 71 is used as the predetermined distribution model. The Gaussian distribution function 71 has variance σ1. For example, as illustrated in A of FIG. 11, the Gaussian distribution function 71 is assigned to the passage trajectory 65c. The Gaussian distribution function 71 has the variance σ1 centered on respective points on the passage trajectory 65c. As a result, the distribution information 70 is generated. In the distribution information 70, distribution values depending on the Gaussian distribution function 71 are provided along the passage trajectory 65c. Distribution information is also generated for the other passage trajectories 65b and 65d by using the Gaussian distribution function 71 having the variance σ1.

B of FIG. 11 illustrates distribution values x (Gaussian distribution functions 71) of surroundings of the respective passage trajectories 65b to 65d (passage points 66b to 66d) in an overlapping manner. For example, three distribution values x are provided at any point on a horizontal axis illustrated in B of FIG. 11. The trajectory generation unit 55 extracts a maximum distribution value x from the distribution values x of the respective passage trajectories 65b to 65d. Information including the maximum distribution value x is generated as goal trajectory information 72. Note that, in B of FIG. 11, dotted lines represent the Gaussian distribution functions 71, and a solid line represents the goal trajectory information 72. In addition, a vertical axis in B of FIG. 11 represents the distribution values x.

(f) of FIG. 9 schematically illustrates the goal trajectory information 72 generated along the planned route. The goal trajectory information 72 indicates probability that the other vehicles 12 have passed in the past by using values of the distribution values.

For example, a location with a high distribution value is assumed to be a location with high probability that the other vehicles 12 have passed. Therefore, by moving the own vehicle 11 along locations with high distribution values, it is possible to drive at locations with high probability that the other vehicles 12 have passed. On the other hand, a location with a low distribution value is assumed to be a location through which the other vehicles 12 have not passed for some reason. Therefore, it is highly possible that the location with the low distribution value is a location that is not appropriate for the own vehicle 11 to travel.

In addition, the width of distribution of the goal trajectory information 72 represents a degree of concentration of the passage trajectories 65 of the other vehicles 12, or the like. This makes it possible to cause the own vehicle 11 to travel at locations through which the majority of the other vehicles 12 have passed. This makes it possible to achieve autonomous driving or the like in such a manner that the own vehicle 11 naturally avoids obstacles or the like avoided by the other vehicles 12 while traveling, for example.

As described above, the goal trajectory information 72 is information that stochastically represents a trajectory the own vehicle 11 should follow. In other words, it can be said that the goal trajectory information 72 (the distribution values) functions as a map that stochastically indicates locations appropriate for the own vehicle 11 to travel. By stochastically represents the goal trajectory information as described above, it is possible to easily execute a process of passing through other locations with relatively high probabilities even in a situation where a location with high probability is blocked by an obstacle, for example.

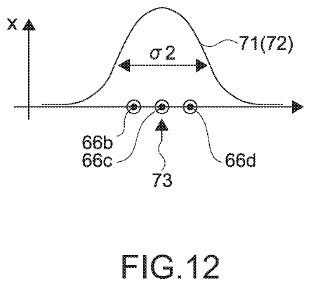

FIG. 12 is a schematic diagram illustrating another example of goal trajectory information generated on the basis of distribution information. In FIG. 12, distribution information is generated by using a Gaussian distribution function 71 having variance σ2 depending on spread of the passage points 66b to 66d. For example, with regard to a location with wide spread of the passage points 66 (a location having a few passage trajectories 65) or the like, the variance σ2 is set to a large value and a wide Gaussian distribution function 71 is used. Conversely, with regard to a location at which the passage points 66 (the passage trajectories 65) are concentrated, a narrow Gaussian distribution function 71 is used.

The trajectory generation unit 55 generates distribution information by disposing the Gaussian distribution function 71 having variance σ2 at a center position 73 obtained by averaging the locations of the respective passage points 66b to 66d. Accordingly, the distribution information is a map representing distribution values x depending on degrees of concentration or the like of the passage trajectories 65. In this case, it is possible to use the distribution information as the goal trajectory information 72 without any change.

It is possible to easily generate the goal trajectory information 72 by using the method illustrated in FIG. 12 and calculating spread or the like of the passage points 66 on the respective passage trajectories 65, for example. In addition, it is possible to perform a process of searching for a shortest route or the like in a short time because the goal trajectory information 72 is generated as distribution having a single peak value. Note that the present technology is not limited to the case of generating the goal trajectory information 72 by using the method described with reference to FIG. 11, FIG. 12, or the like. It is also possible to use any method capable of generating the goal trajectory information 72 from the passage trajectories 65 of other vehicles 12.

Returning to FIG. 8, the trajectory generation unit 55 generates a cost map on the basis of the goal trajectory information 72 (Step 107). Specifically, a grid is generated in a region of surroundings of the own vehicle 11. The grid divides the region at predetermined intervals (for example, approximately 1 m). Each grid point i is provided with a difference value (1−xi) obtained by subtracting a distribution value xi (a probability value) of the goal trajectory information 72 corresponding to each grid point i from 1. Information regarding the difference values associated with locations in the grid is used as the cost map.

As described above, the distribution value xi of the goal trajectory information 72 is a value representing a location appropriate for the own vehicle 11 to travel by using probability. Therefore, by using the difference values between the distribution values xi and 1, it is possible to represent a movement cost necessary for movement of the own vehicle. In other words, it can be said that the difference value is probability representation of the movement cost.

For example, a location with a small distribution value xi is assumed to be a location where a few other vehicles 12 travel, and a high movement cost (difference value) is set. On the other hand, a location with a large distribution value xi is assumed to be a location where the other vehicles 12 have traveled, and a low movement cost (difference value) is set.

A method of generating the cost map is not limited. For example, it is possible to generate the cost map by using any method capable of converting the goal trajectory information 72 into the movement cost. In addition, it is possible to appropriately set the predetermined intervals in accordance with accuracy or the like of the cost map. The cost map generated by the trajectory generation unit 55 is output to the control unit 47.

The control unit 47 controls movement of the own vehicle 11 by using the cost map (Step 108). According to the present embodiment, the control unit 47 controls the movement while using the goal trajectory information 72 (the cost map) represented by the probabilities as a goal control signal and automatically avoiding obstacles.

For example, the control unit 47 detects obstacles such as vehicles and pedestrians around the own vehicle 11 on the basis of output from the surrounding sensor 31 (the image sensor 32 and the distance sensor 33). Next, movement costs of grid points corresponding to locations where the obstacles have been detected are overwritten with high values. At this time, each of grid points around the grid points of the obstacles is overwritten with a new movement cost in such a manner that the movement cost decreases in stages as distances to the obstacles get longer.

As described above, the cost map is overwritten with information regarding the obstacles around the own vehicle 11 on the basis of information regarding the surrounding sensor 31. This makes it possible to generate the cost map including the goal trajectory information 72 and the information regarding obstacles around the current location of the own vehicle 11.

The control unit 47 searches for a shortest trajectory from the current location 60 to the nearest route point 67 on the cost map overwritten with the information of obstacles. This search result is used as a driving trajectory the own vehicle 11 will finally follow. A method of searching for the shortest trajectory is not limited. For example, it is possible to use a search algorithm such as an A* algorithm, machine learning, or the like appropriately.

The control unit 47 appropriately controls the steering apparatus 40, the braking apparatus 41, the vehicle body acceleration apparatus 42, and the like, and controls movement of the own vehicle 11 in such a manner that the own vehicle 11 follows the driving trajectory. This makes it possible for the own vehicle 11 to drive in a safe way while aiming for the goal trajectory and avoiding actual obstacles. In addition, by performing control (movement control based on the goal trajectory information 72) while aiming for the goal trajectory, it is possible to follow the driving trajectory depending on the passage trajectories 65 through which other vehicles 12 have traveled in the past. This makes it possible to naturally avoid unexpected lane closure, roadworks, parked vehicles, and the like, for example.

As described above, the trajectory generation apparatus 50 according to the present embodiment acquires movement information related to movement of other automobiles 10. The goal trajectory information 72 is generated on the basis of the acquired movement information. The goal trajectory information 72 is used as a goal when the automobile 10 of the control target moves. It is possible to flexibly control movement in conformity with an actual movement environment by using the goal trajectory information 72 and controlling movement of the automobile 10.

A method of using detailed map information is considered as a method of calculating an autonomous driving route. The detailed map is generated by measuring detailed 3D models of roads and the like. An autonomous vehicle uses the detailed map information, refers to series data regarding latitudes and longitudes of passable routes, calculates locations of obstacles and other vehicles from information of many sensors such as the RGB cameras, and plans a driving route the own vehicle should follow. There is a possibility that huge cost is necessary for creating the detailed 3D models of roads in a wide area. In addition, it is desirable to periodically update the map information in response to change due to new construction, abandon, or reconstruction of roads. Therefore, there is a possibility that a maintenance cost is permanently necessary.

In addition, with regard to an actual traffic environment, passable lanes may be temporarily changed due to parked vehicles, roadworks, road closure, lane closure, or the like. In such a case, there is a possibility that it is not possible to appropriately and flexibly control the vehicle in accordance with a situation when using autonomous driving based on detailed map information, because the map information does not reflect the temporary change in passible lanes or the like. As a result, there is a possibility that unnatural speed reduction, stopping, lane change, or the like disturbs a flow of surrounding vehicles.

The trajectory generation apparatus 50 according to the present embodiment generates the goal trajectory information 72 related to a goal trajectory that is a goal for movement of the automobile 10 on the basis of the passage trajectories 65 through which other automobiles 10 have passed. In other words, the goal trajectory information 72 of the automobile 10 is generated with reference to the passage trajectories 65 of the other automobiles 10 that have already passed through a route the automobile 10 will follow. Accordingly, it is possible for the automobile 10 to generate a trajectory the automobile 10 should follow, without using the detailed map information. This makes it possible to cut a cost for creating or maintaining the detailed map information or the like, and drastically reduce a running cost or the like of the whole system.

In addition, by using the goal trajectory information 72 and controlling movement of the automobile 10, it is possible to flexibly deal with temporary change in passible lane. For example, a vehicle-free zone does not have any past driving history (passage trajectory) of other automobiles 10. Therefore, a driving trajectory to such a zone is not generated in the first place. This makes it possible to naturally avoid the vehicle-free area even in the case where the passible lane or the like is temporarily changed. As a result, it is possible to achieve autonomous driving for controlling movement of the automobile 10 in such a manner that the movement of the automobile 10 fits into an actual traffic environment without disturbing a smooth flow of traffic.

### Second Embodiment

A trajectory generation apparatus according to a second embodiment of the present technology will be described. Hereinafter, description will be omitted or simplified with regard to structural elements and effects that are similar to those of the automobile 10 and the trajectory generation apparatus 50 described in the above embodiment.

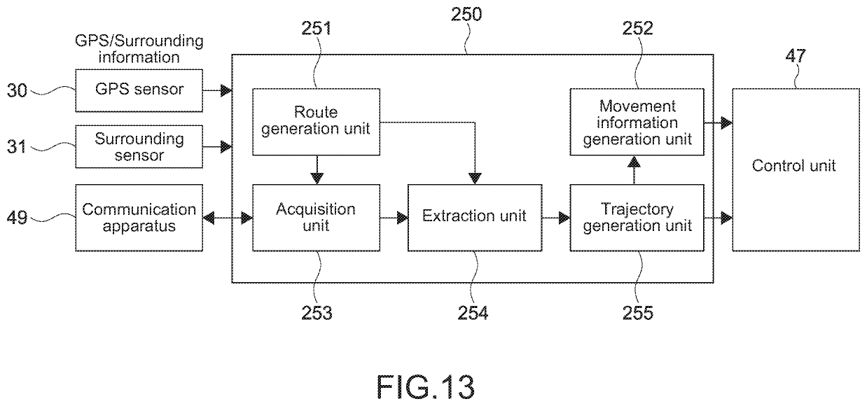

FIG. 13 is a block diagram illustrating a functional configuration example of a trajectory generation apparatus 250 according to the second embodiment. According to the present embodiment, goal trajectory information regarding the own vehicle 11 is generated on the basis of goal trajectory information of other vehicles 12.

As illustrated in FIG. 13, in the trajectory generation apparatus 250, goal trajectory information 72 generated by a trajectory generation unit 255 is output to a movement information generation unit 252. The movement information generation unit 252 generates movement information and uploads the movement information to the database 22. In the movement information, the goal trajectory information 72 is associated with the vehicle ID and surrounding information of the own vehicle 12. At this time, it is also possible to generate movement information including a cost map generated from the goal trajectory information 72.

As a result, the database 22 accumulates various kinds of goal trajectory information 72 (movement information) generated by a plurality of automobiles 10. As described with reference to (f) of FIG. 9, the goal trajectory information 72 is information regarding a map (probability distribution) that represents locations appropriate for the automobile 10 to travel as probabilities. The goal trajectory information 72 accumulated in the database 22 is searched with reference to location information or the like on the map, for example.

An acquisition unit 253 of the automobile 10 (the own vehicle 11) of a control target acquires movement information including the goal trajectory information of other vehicles 12. For example, goal trajectory information (movement information) whose location on a map is included in the to-be-passed region 68 of the own vehicle 11 is acquired. In other words, the goal trajectory information that overlaps the to-be-passed region 68 is acquired. According to the present embodiment, goal trajectory information of another vehicle 12 corresponds to information related to another goal trajectory that is a goal for movement of the other mobile object.

An extraction unit 254 calculates correlation values between the goal trajectory information of other vehicles 12 and the planned route 62 of the own vehicle 11. For example, correlation values (inter-series distances or the like) between respective points on the planned route 62 and respective points on a line connecting peak values of probability distribution of the goal trajectory information are appropriately calculated. Next, movement information of one of the other vehicles 12 having the goal trajectory information that is highly correlated to the planned route 62 is extracted as reference movement information. Note that, in the case where movement information of the other vehicle 12 includes surrounding information or the like, it is possible to perform a process of extracting the reference movement information by using the surrounding information (see Step 104 in FIG. 8).

The trajectory generation unit 255 generates goal trajectory information of the own vehicle 11 on the basis of the goal trajectory information of the other vehicles 12. For example, a process (synthesis process) of superimposing, over one another, pieces of goal trajectory information of the other vehicles 12 or the like is executed. The synthesis process is a process of adding or multiplying probability values of designated points of similar latitudes and longitudes in respective maps (goal trajectory information), for example. Of course, the process is not limited thereto. A map of the synthesized probability values serves as the goal trajectory information of the own vehicle 11.

The generated goal trajectory information is output to the control unit 47, and is used for controlling movement of the own vehicle 11. Even in the case of using the goal trajectory information of the other vehicles 12 as described above, it is possible to flexibly control movement of the automobile 10 (the own vehicle 11) in conformity with the actual movement environment.

In addition, the present technology is not limited to the case of using the past goal trajectory information of the other vehicles 12. For example, it is possible to use goal trajectory information or the like of the other vehicles 12 generated at the timing of controlling movement of the own vehicle 11. For example, it is possible to use vehicle-to-vehicle communication or the like and directly acquire goal trajectory information that is being currently used by another vehicle 12 traveling around (such as in front of or after, for example) the own vehicle 11. This makes it possible to omit the process of extracting necessary information or the like and easily control the own vehicle 11.

### Third Embodiment

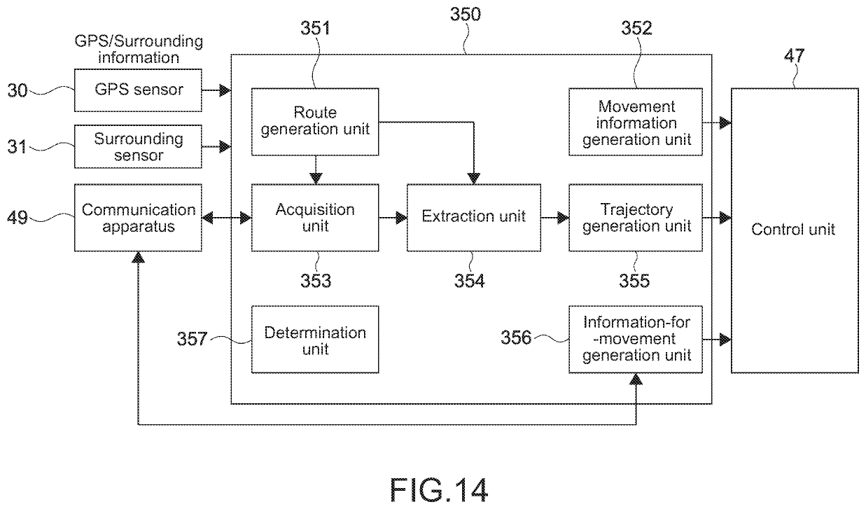

FIG. 14 is a block diagram illustrating a functional configuration example of a trajectory generation apparatus 350 according to a third embodiment. According to the present embodiment, it is possible to generate, as information to be used for controlling movement of the own vehicle 11, goal trajectory information based on movement information of other vehicles 12 and information for movement based on map information.

The trajectory generation apparatus 350 includes a route generation unit 351, a movement control unit 352, an acquisition unit 353, an extraction unit 354, and a trajectory generation unit 355. The route generation unit 351, the movement control unit 352, the acquisition unit 353, the extraction unit 354, and the trajectory generation unit 355 are configured in ways similar to the route generation unit 51, the movement control unit 52, the acquisition unit 53, the extraction unit 54, and the trajectory generation unit 355 that have been described with reference to FIG. 4. In addition, the trajectory generation apparatus 350 includes an information-for-movement generation unit 356 and a determination unit 357.

The information-for-movement generation unit 356 generates information for movement of the own vehicle 11 on the basis of map information. The map information is appropriately downloaded from the server apparatus 21 or the like via the communication apparatus 49, for example. For example, detailed map information generated by measuring detailed 3D models of roads and the like is used as the map information. Accordingly, the map information includes detailed information such as the width of a road or the shape of an intersection through which the own vehicle 11 is traveling. Note that a specific configuration and the like of the map information are not limited. Hereinafter, the map information is referred to as the detailed map information.

The information for movement of the own vehicle 11 is information indicating a location, a direction, or the like to which the own vehicle 11 should move. For example, a cost map related to a movement cost of the own vehicle 11 or the like is generated as the information for movement. For example, a cost map of surroundings of the own vehicle 11 or the like is generated on the basis of a detailed 3D model of the detailed map information. At this time, a current location of the own vehicle 11 acquired by the GPS sensor 30, information regarding obstacles detected from surrounding information (image information, depth information, or the like) of the own vehicle 11, or the like is appropriately used.

Note that the type, form, and the like of the information for movement are not limited. For example, information for movement is appropriately used as long as it is possible to move the own vehicle 11 with a desired accuracy. According to the present embodiment, the information-for-movement generation unit 356 corresponds to the third generation unit. In addition, the information for movement of the own vehicle 11 corresponds to information for movement of the target mobile object.

The determination unit 357 determines whether it is possible for the information-for-movement generation unit 356 to execute a process of generating the information for movement. For example, it is determined whether it is possible to execute the process of generating information for movement (such as the cost map) in accordance with a detailed map information acquisition status, a GPS signal reception status of the GPS sensor 30, or the like. In addition, the method of the determination process performed by the determination unit 357 or the like is not limited.

According to the present embodiment, a process of generating the goal trajectory information and a process of generating the information for movement are alternately performed on the basis of a determination result of the determination unit 357.

For example, in the case where the determination unit 357 determines that it is possible to execute the process of generating the information for movement, the goal trajectory information is not generated but the information-for-movement generation unit 356 generates the information for movement. In this case, the information for movement is output to the control unit 47 and is used for controlling movement of the own vehicle 11.

On the other hand, in the case where the determination unit 357 determines that it is not possible to execute the process of generating the information for movement, the process of generating the goal trajectory information is executed. In other words, it can be said that the trajectory generation unit 355 generates the goal trajectory information in the case where it is not possible for the information-for-movement generation unit 356 to execute the process of generating the information for movement.

Examples of the case where it is not possible to execute the process of generating the information for movement include a case where it is not possible to acquire accurate detailed map information. For example, it may be difficult to acquire the accurate detailed information in the case where the detailed map information is not generated in a section through which the own vehicle 11 travels, or in the case where new road information updated due to roadworks or the like has not been reflected yet.

In addition, it may be difficult to generate the information for movement (such as a cost map) by using the detailed map information in the case where a GPS signal reception status is poor, or in the case where it is not possible to receive the GPS signal (such as a road in a tunnel, a road near a high-rise building, or an indoor space). In addition, it may be impossible for the information-for-movement generation unit 356 to perform the process of generating the information for movement because of various causes.

As described above, in the case where it is determined that it is not possible to execute the process of generating the information for movement, the trajectory generation unit 355 executes the process of generating the goal trajectory information. The generated goal trajectory information is output to the control unit 47, and is used for controlling movement of the own vehicle 11.

This makes it possible to smoothly control movement without disturbing a flow of traffic even in the case where a lane is added or changed because of roadworks or the like, for example. As a result, it is possible to sufficiently prevent the own vehicle 11 from unnatural lane change, quick stop, and the like, and it is possible to achieve safe and reliable autonomous movement control.

### Other Embodiments

The present technology is not limited to the above-described embodiments. Various other embodiments are possible.

In the above-described embodiments, the current location of the automobile is detected by using the GPS sensor. The present technology is not limited thereto. It is also possible to detect the current location by using the surrounding information (image information, depth information, or the like) of the automobile, for example. For example, it is possible to use a self location estimation process such as simultaneous localization and mapping (SLAM) as a process of detecting a location by using the surrounding information.

For example, in the case where the GPS sensor is not used, movement information of another automobile that is necessary for generating goal trajectory information is extracted by using the surrounding information (Step 104 or the like in FIG. 8). Therefore, it is possible to appropriately detect a current location of an automobile and generate the goal trajectory information even in the case where it is not possible to use the GPS sensor.

In the above-described embodiments, the trajectory generation apparatus installed in the automobile generates the goal trajectory information (a contrast map) to be used for controlling movement of the automobile including the trajectory generation apparatus. The present technology is not limited thereto. For example, the function of generating goal trajectory information of the automobile of the control target may be installed in the server apparatus connected to the network. In this case, the server apparatus functions as the information processing apparatus according to the present technology.

The server apparatus is connected to a target automobile of the control target and other respective automobiles that are different from the target automobile, in such a manner that they are capable of communicating with each other via the network. In addition, the server apparatus includes an acquisition unit, a trajectory generation unit, and a transmission unit. The acquisition unit acquires movement information related to movement of the other automobiles from the database. The trajectory generation unit generates goal trajectory information of the target automobile on the basis of movement information. In addition, the transmission unit transmits, to the target automobile and via the network, the goal trajectory information generated by the trajectory generation unit.

For example, the target automobile transmits movement information to the server apparatus. The movement information includes a current location, a planned route, surrounding information, and the like of the target automobile. The acquisition unit of the server apparatus acquires movement information of the other automobiles stored in the database on the basis of current information of the target automobile. For example, the movement information of the other automobiles that is necessary for generating the goal trajectory information of the target automobile is acquired appropriately. The trajectory generation unit of the server apparatus generates the goal trajectory information on the basis of the movement information of the other automobiles. The transmission unit of the server apparatus transmits the generated goal trajectory information to the target automobile. Movement of the target automobile is controlled while aiming for the goal trajectory information generated by the server apparatus and avoiding obstacles or the like.

Even in the case where the server apparatus generates the goal trajectory information of the target automobile, it is possible to flexibly control the movement in conformity with an actual traffic situation by using the movement information (passage trajectories, goal trajectory information, or the like) of other automobiles. In addition, it is not necessary for the target automobile to download the movement information or the like of the other automobiles. Therefore, it is possible to sufficiently reduce data communication load or the like. This makes it possible to shorten time necessary to generate the goal trajectory information or the like, for example.

As described above, when a computer (the trajectory generation apparatus) installed in the automobile and another computer (the server apparatus) capable of communication via the network work in conjunction with each other, the information processing method and program according to the present technology are executed, and this makes it possible to configure the information processing apparatus according to the present technology.

That is, the information processing method and the program according to the present technology may be executed not only in a computer system configured by a single computer but also in a computer system in which a plurality of computers operates cooperatively. It should be noted that, in the present disclosure, the system means an aggregate of a plurality of components (apparatus, module (parts), and the like) and it does not matter whether all the components are housed in the same casing. Therefore, a plurality of apparatuses housed in separate casings and connected to one another via a network and a single apparatus having a plurality of modules housed in a single casing are both the system.

The execution of the information processing method and the program according to the present technology by the computer system includes, for example, both of a case where the acquisition of movement information of other mobile objects, generation of goal trajectory information, and the like are executed by a single computer and a case where those processes are executed by different computers, for example. Further, the execution of the respective processes by a predetermined computer includes causing the other computer to execute some or all of those processes and acquiring results thereof.

That is, the information processing method and the program according to the present technology are also applicable to a cloud computing configuration in which one function is shared and cooperatively processed by a plurality of apparatuses via a network.

In the above-described embodiments, information regarding a passage trajectory through which an automobile has passed and information (goal trajectory information) regarding a goal trajectory of the automobile are exemplified as the movement information related to movement of the automobile. The present technology is not limited thereto. It is possible to use, as the movement information, any information related to movement of the automobile or the like.

In the above-described embodiments, each of the plurality of automobiles included in the movement control system uploads the movement information. Next, movement information related to movement of other vehicles uploaded by the other vehicles is acquired for controlling movement of the own vehicle, and a goal trajectory of the own vehicle is generated. The present technology is not limited thereto. It is also possible to use movement information uploaded by the other vehicles while treating, as a control target, an automobile that does not upload its own movement information, for example.

In the above-described embodiments, the description has been given while using the automobile as an example of the mobile object. However, the present technology is applicable to any type of mobile object and the like. For example, an aerial drone capable of autonomous flight or the like is considered as the mobile object. For example, the aerial drone includes the GPS sensor, the surrounding sensor, or the like, and uploads movement information related to its movement (flight) and the like to the database. As a result, the database accumulates information regarding three-dimensional flight trajectories of a plurality of aerial drones at various locations or the like.

By using such information, it is possible to control flight of the aerial drone while avoiding obstacles on a route, a flight prohibited airspace, a space that has strong winds blowing through buildings and therefore that is not appropriate for flight, and the like in advance, for example. By using movement information of the other aerial drones as described above, it is possible to flexibly control the flight in conformity with an actual flight environment and the like.

In addition, the technology according to the present disclosure can be applied to various products. For example, the technology according to the present disclosure may be realized as an apparatus installed in any kind of mobile object such as vehicles, electric vehicles, hybrid electric vehicles, motorcycles, bicycles, personal transporters, airplanes, drones, ships, robots, heavy equipment, agricultural machinery (tractors), and the like, for example.

Out of the feature parts according to the present technology described above, at least two feature parts can be combined. That is, the various feature parts described in the embodiments may be arbitrarily combined irrespective of the embodiments. Further, various effects described above are merely examples and are not limited, and other effects may be exerted.

Note that the present technology may also be configured as below.

(1) An information processing apparatus including:

an acquisition unit that acquires movement information related to movement of another mobile object different from a target mobile object that is a control target; and

a first generation unit that generates information related to a goal trajectory that is a goal for movement of the target mobile object on the basis of the acquired movement information of the other mobile object.

(2) The information processing apparatus according to (1), in which

the movement information includes information regarding a passage trajectory through which the other mobile object has passed, and

the first generation unit generates the information related to the goal trajectory of the target mobile object on the basis of the passage trajectory of the other mobile object.

(3) The information processing apparatus according to (2), in which

the movement information includes identification information for identifying the other mobile object, and information regarding a passage point on the passage trajectory associated with the identification information.

(4) The information processing apparatus according to (3), in which

the movement information includes surrounding information of the other mobile object detected at a timing of passing through the passage point.

(5) The information processing apparatus according to (4), in which

the surrounding information includes at least one of image information or depth information of surroundings of the other mobile object.

(6) The information processing apparatus according to any one of (2) to (5), further including a second generation unit that generates a planned route from a current location of the target mobile object to a destination of the target mobile object.
(7) The information processing apparatus according to (6), in which

the acquisition unit acquires the movement information of the other mobile object having passed through a region including the current location of the target mobile object and a nearest route point on the planned route as viewed from the current location of the target mobile object.

(8) The information processing apparatus according to (6) or (7), in which

the first generation unit generates information related to the goal trajectory from the current location of the target mobile object to a nearest route point on the planned route.

(9) The information processing apparatus according to any one of (6) to (8), further including an extraction unit that extracts, from the movement information of the other mobile object acquired by the acquisition unit, reference movement information to be used for generating the information related to the goal trajectory, in which

the first generation unit generates the information related to the goal trajectory on the basis of the extracted reference movement information.

(10) The information processing apparatus according to (9), in which

the extraction unit calculates a first correlation value that represents correlation between the planned route of the target mobile object and the passage trajectory of the other mobile object, and extracts the reference movement information on the basis of the first correlation value.

(11) The information processing apparatus according to (9) or (10), in which

the extraction unit extracts the reference movement information on the basis of a distance between the current location of the target mobile object and a passage point on the passage trajectory of the other mobile object.

(12) The information processing apparatus according to any one of (9) to (11), in which

the extraction unit calculates a second correlation value that represents correlation between surrounding information of the current location of the target mobile object and surrounding information of a passage point on the passage trajectory of the other mobile object, and extracts the reference movement information on the basis of the second correlation value.

(13) The information processing apparatus according to any one of (1) to (12), further including:

a third generation unit that generates information for movement of the target mobile object on the basis of map information; and

a determination unit that determines whether it is possible for the third generation unit to execute a process of generating the information for movement of the target mobile object, in which

the first generation unit generates the information regarding the goal trajectory in the case where it is not possible for the third generation unit to execute the process of generating the information for movement of the target mobile object.

(14) The information processing apparatus according to any one of (1) to (13), in which

the information processing apparatus is installed in the target mobile object, and

the acquisition unit acquires the movement information from a server that is connected to the target mobile object and the other mobile object in such a manner that the server is capable of communicating with each of the target mobile object and the other mobile object via a network.

(15) The information processing apparatus according to any one of (1) to (13), in which

the information processing apparatus is a server that is connected to the target mobile object and the other mobile object in such a manner that the server is capable of communicating with each of the target mobile object and the other mobile object via a network.

(16) The information processing apparatus according to (15), further including a transmission unit that transmits, to the target mobile object and via the network, the information related to the goal trajectory generated by the first generation unit.
(17) A vehicle including:

an acquisition unit that acquires movement information related to movement of another vehicle different from an own vehicle that is a control target;

a first generation unit that generates information related to a goal trajectory that is a goal for movement of the own vehicle on the basis of the acquired movement information of the other vehicle; and

a movement control unit that controls movement of the own vehicle on the basis of the generated information related to the goal trajectory.

(18) A mobile object including:

an acquisition unit that acquires movement information related to movement of another mobile object different from a mobile object that is a control target;

a first generation unit that generates information related to a goal trajectory that is a goal for movement of the mobile object that is the control target, on the basis of the acquired movement information of the other mobile object; and

a movement control unit that controls movement of the mobile object that is the control target on the basis of the generated information related to the goal trajectory.

(19) An information processing method to be executed by a computer system, the information processing method including:

acquiring movement information related to movement of another mobile object different from a target mobile object that is a control target; and

generating information related to a goal trajectory that is a goal for movement of the target mobile object on the basis of the acquired movement information of the other mobile object.

(20) A program that causes a computer system to execute a process including:

acquiring movement information related to movement of another mobile object different from a target mobile object that is a control target; and

generating information related to a goal trajectory that is a goal for movement of the target mobile object on the basis of the acquired movement information of the other mobile object.

### REFERENCE SIGNS LIST

10 automobile
11 own vehicle
12 another vehicle
21 server apparatus
22 database
50, 250, 350 trajectory generation apparatus
51, 251, 351 route generation unit
52, 252, 352 movement information generation unit
53, 253, 353 acquisition unit
54, 254, 354, extraction unit
55, 255, 355 trajectory generation unit
356 information-for-movement generation unit
357 determination unit
60 current location
61 destination
62 planned route
64 route point
65, 65a to 65d passage trajectory
66, 66b to 66d passage point
70 distribution information
71 Gaussian distribution function
72 goal trajectory information
100 movement control system

1. An information processing apparatus comprising:
an acquisition unit that acquires movement information related to movement of another mobile object different from a target mobile object that is a control target; and
a first generation unit that generates information related to a goal trajectory that is a goal for movement of the target mobile object on a basis of the acquired movement information of the other mobile object.

2. The information processing apparatus according to claim 1, wherein
the movement information includes information regarding a passage trajectory through which the other mobile object has passed, and
the first generation unit generates the information related to the goal trajectory of the target mobile object on a basis of the passage trajectory of the other mobile object.

3. The information processing apparatus according to claim 2, wherein
the movement information includes identification information for identifying the other mobile object, and information regarding a passage point on the passage trajectory associated with the identification information.

4. The information processing apparatus according to claim 3, wherein
the movement information includes surrounding information of the other mobile object detected at a timing of passing through the passage point.

5. The information processing apparatus according to claim 4, wherein
the surrounding information includes at least one of image information or depth information of surroundings of the other mobile object.

6. The information processing apparatus according to claim 2, further comprising a second generation unit that generates a planned route from a current location of the target mobile object to a destination of the target mobile object.

7. The information processing apparatus according to claim 6, wherein
the acquisition unit acquires the movement information of the other mobile object having passed through a region including the current location of the target mobile object and a nearest route point on the planned route as viewed from the current location of the target mobile object.

8. The information processing apparatus according to claim 6, wherein
the first generation unit generates information related to the goal trajectory from the current location of the target mobile object to a nearest route point on the planned route.

9. The information processing apparatus according to claim 6, further comprising an extraction unit that extracts, from the movement information of the other mobile object acquired by the acquisition unit, reference movement information to be used for generating the information related to the goal trajectory, wherein
the first generation unit generates the information related to the goal trajectory on a basis of the extracted reference movement information.

10. The information processing apparatus according to claim 9, wherein
the extraction unit calculates a first correlation value that represents correlation between the planned route of the target mobile object and the passage trajectory of the other mobile object, and extracts the reference movement information on a basis of the first correlation value.

11. The information processing apparatus according to claim 9, wherein
the extraction unit extracts the reference movement information on a basis of a distance between the current location of the target mobile object and a passage point on the passage trajectory of the other mobile object.

12. The information processing apparatus according to claim 9, wherein
the extraction unit calculates a second correlation value that represents correlation between surrounding information of the current location of the target mobile object and surrounding information of a passage point on the passage trajectory of the other mobile object, and extracts the reference movement information on a basis of the second correlation value.

13. The information processing apparatus according to claim 1, further comprising:
a third generation unit that generates information for movement of the target mobile object on a basis of map information; and
a determination unit that determines whether it is possible for the third generation unit to execute a process of generating the information for movement of the target mobile object, wherein
the first generation unit generates the information regarding the goal trajectory in a case where it is not possible for the third generation unit to execute the process of generating the information for movement of the target mobile object.

14. The information processing apparatus according to claim 1, wherein
the information processing apparatus is installed in the target mobile object, and
the acquisition unit acquires the movement information from a server that is connected to the target mobile object and the other mobile object in such a manner that the server is capable of communicating with each of the target mobile object and the other mobile object via a network.

15. The information processing apparatus according to claim 1, wherein
the information processing apparatus is a server that is connected to the target mobile object and the other mobile object in such a manner that the server is capable of communicating with each of the target mobile object and the other mobile object via a network.

16. The information processing apparatus according to claim 15, further comprising a transmission unit that transmits, to the target mobile object and via the network, the information related to the goal trajectory generated by the first generation unit.

17. A vehicle comprising:
an acquisition unit that acquires movement information related to movement of another vehicle different from an own vehicle that is a control target;
a first generation unit that generates information related to a goal trajectory that is a goal for movement of the own vehicle on a basis of the acquired movement information of the other vehicle; and
a movement control unit that controls movement of the own vehicle on a basis of the generated information related to the goal trajectory.

18. A mobile object comprising:
an acquisition unit that acquires movement information related to movement of another mobile object different from a mobile object that is a control target;
a first generation unit that generates information related to a goal trajectory that is a goal for movement of the mobile object that is the control target, on a basis of the acquired movement information of the other mobile object; and
a movement control unit that controls movement of the mobile object that is the control target on a basis of the generated information related to the goal trajectory.

19. An information processing method to be executed by a computer system, the information processing method comprising:
acquiring movement information related to movement of another mobile object different from a target mobile object that is a control target; and
generating information related to a goal trajectory that is a goal for movement of the target mobile object on a basis of the acquired movement information of the other mobile object.

20. A program that causes a computer system to execute a process comprising:
acquiring movement information related to movement of another mobile object different from a target mobile object that is a control target; and
generating information related to a goal trajectory that is a goal for movement of the target mobile object on a basis of the acquired movement information of the other mobile object.
